(19) United States
(12) Patent Application Publication
(10) Pub. No.: US 2026/0067401 A1
(43) Pub. Date: Mar. 5, 2026

(54) SYSTEMS AND METHODS FOR TRANSITIONING MULTI-CHANNEL CALL CENTER CUSTOMER EXPERIENCE VIA USER INTERFACES

(71) Applicant: AFINITI Al LIMITED, Hamilton, HM 11 (BM)

(72) Inventors: Hassan Afzal, Miami, FL (US); Syed Rameez Talat

(21) Appl. No.: 19/104,407

(22) PCT Filed: Aug. 24, 2023
(86) PCT No.: PCT/US23/31023

§ 371 Date: Feb. 18, 2025

Related U.S. Application Data
(60) Provisional application No. 63/400,928, filed on Aug. 25, 2022.

(51) Int. Cl. H04M 3/51; H04M 3/523

(52) U.S. Cl. CPC H04M 3/5175; H04M 3/5233; H04M 2201/42

(57) ABSTRACT

Systems and methods are disclosed for transitioning multi-channel call center customer experience via user interfaces. An example method includes obtaining, by a communications server, contact information of a contact. The example method includes establishing, by the communications server, a first connection between a contact and an agent terminal over a first communication channel. The example method includes establishing, by the communications server, a second connection between the contact and the agent terminal over a second communication channel. The example method includes sending a first communication to the contact from the agent terminal across the second communication channel. The example method includes receiving, at the agent terminal, a second communication from the contact across the second communication channel.

### CROSS-REFERENCE TO RELATED APPLICATION

This international patent application claims priority to U.S. Provisional Application No. 63/400,928, filed Aug. 25, 2022, which is hereby incorporated by reference in its entirety as if fully set forth herein.

### FIELD OF THE DISCLOSURE

The present disclosure generally relates to systems and methods within contact centers, and more particularly, to systems and methods within contact centers for managing a multi-channel call center customer experience.

### BACKGROUND OF THE DISCLOSURE

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy. In some contact centers, contacts or agents are assigned into different “skill groups” or “queues” prior to applying a FIFO assignment strategy within each such skill group or queue. These “skill queues” may also incorporate strategies for prioritizing individual contacts or agents within a baseline FIFO ordering. For example, a high-priority contact may be given a queue position ahead of other contacts who arrived at an earlier time, or a high-performing agent may be ordered ahead of other agents who have been waiting longer for their next call. Regardless of such variations in forming one or more queues of callers or one or more orderings of available agents, contact centers typically apply FIFO to the queues or other orderings. Once such a FIFO strategy has been established, assignment of contacts to agents is automatic, with the contact center assigning the first contact in the ordering to the next available agent, or assigning the first agent in the ordering to the next arriving contact. In the contact center industry, the process of contact and agent distribution among skill queues, prioritization and ordering within skill queues, and subsequent FIFO assignment of contacts to agents is typically managed by a system referred to as an “Automatic Call Distributor”(“ACD”).

Moreover, some contact centers may use a “performance based routing” or “PBR” algorithm or approach to ordering the queue of available agents or, occasionally, contacts. For example, when a contact arrives at a contact center with a plurality of available agents, the ordering of agents available for assignment to that contact would be headed by the highest-performing available agent (e.g., the available agent with the highest sales conversion rate, the highest customer satisfaction scores, the shortest average handle time, the highest performing agent for the particular contact profile, the highest customer retention rate, the lowest customer retention cost, the highest rate of first-call resolution). PBR ordering strategies attempt to maximize the expected outcome of each contact-agent interaction but do so typically without regard for utilizing agents in a contact center uniformly. Consequently, higher-performing agents may receive noticeably more contacts and feel overworked due to consistently maximized capacity, while lower-performing agents may receive fewer contacts and idle longer due to consistently underutilized capacity, potentially reducing their opportunities for training and improvement as well as potentially reducing their compensation.

These agent assignment issues are further compounded based on differences in the contact response patterns and contact expectations during agent interactions over the different channels. In particular, responses in these different channels, and indeed the conversations themselves, sometimes occur/last hours or days after the initial message is sent. When conversations over such channels last long enough, the contact may disconnect from the conversation without receiving a satisfactory outcome. For example, a contact may communicate with an agent via an Internet chat during working hours. When the contact leaves work for the day, the contact may disconnect from the conversation with the agent regardless of the outcome. The agent may then be unable to converse with the contact, despite the fact that the contact has other communication channels available (e.g., text message, phone call, etc.). The contact may return to work the next day, and will be unable to continue their prior conversation, thereby wasting significant amounts of time attempting to re-familiarize another agent with the contact's issue(s)/reason(s) for requesting assistance.

### SUMMARY OF THE DISCLOSURE

The present disclosure generally relates to methods implemented for contact centers. In particular, systems and methods are disclosed for a multi-channel contact center, and transitioning a multi-channel call center customer experience via user interfaces. The present disclosure describes techniques for receiving contact communications across multiple communication channels at a single agent terminal. These techniques may enable a contact to interact with a single agent through any number of communication channels, and the agent may have an aggregate view of each communication channel on a graphical user interface (GUI) that displays communications from each communication channel to the agent.

To illustrate, a first agent working as part of a conventional contact center may initialize a chat interaction with a contact across an Internet chat. The contact may access the Internet chat through a desktop computer that is statically located in the contact's home, thereby enabling the contact to browse other websites, check email, etc. while participating in the Internet chat and/or waiting for responses from the first agent. In any event, using the conventional contact center systems, the first agent may receive communications from the contact across the Internet chat communication channel. At some point, the contact may request that the conversation with the first agent continue via text message because the contact is leaving their home and will necessarily need to leave the desktop computer. Conventional contact center systems may not have technical capabilities allowing an agent to interact with a contact on multiple channels. Further, even if the first agent may be able to continue the conversation via text message, conventional contact center systems will not allow the first agent to view the content of the Internet chat during the text message conversation. Thus, the first agent would be forced to manage a disjointed conversation between two different communication channels that may cause the agent to utilize multiple applications and/or devices. Alternatively, different agents may be managing each channel, such that the contact must correspond with multiple agents across multiple channels. As a result, the first agent may forget and/or otherwise lose some of the information that is contained between the two different communication channels and/or a second agent may be wholly unfamiliar with the contacts needs, which can lead to reduced response times, increased chat interaction lengths, reduced agent utilization, and an unsavory user experience for contacts and agents alike.

By contrast, the systems and methods of the present disclosure overcome these and other issues of conventional techniques by providing agents with automatic, efficient, and intuitive access to contacts across multiple communication channels. Namely, the systems and methods of the present disclosure detect/establish connections between a contact and an agent terminal, and enable the agent to send communications to the contact via any of the communication channels corresponding to the detected/established connections. Further, the systems and methods of the present disclosure display all communication between the contact and the agent in a single GUI panel with visual indicators corresponding to the respective communication channels across which the communications are transmitted. In this manner, the systems and methods of the present disclosure enable an agent to quickly and easily track the communication channels used to communicate with the contact and send communications through any communication channel without requiring additional applications or devices.

To illustrate, and in reference to the prior example, the first agent working as part of a contact center utilizing the systems and methods of the present disclosure may initialize a chat interaction with the contact across an Internet chat. The contact may access the Internet chat through the static desktop computer, thereby enabling the contact to browse other websites, check email, etc. while participating in the Internet chat and/or waiting for responses from the first agent. The first agent may receive communications from the contact across the Internet chat communication channel, and the first agent may view those communications in a single panel of a GUI with visual indicators associated with each communication indicating that the communications were transmitted across the Internet chat communication channel. When the contact requests that the conversation continue via text message, the first agent may be able to quickly switch to a text message communication channel, send a confirmatory text through the text message communication channel to the contact's text message-enabled device (e.g., smart phone), and view the confirmatory text and the Internet chat communications together on the single GUI panel. Thus, the first agent can fluidly pivot between/among different available communication channels with a contact while maintaining all prior communications transmitted by the contact/first agent during the chat interaction. As a result, the first agent never forgets and/or otherwise loses the information that is contained between/among the multiple communication channels, which improves agent response times, decreased chat interaction lengths, increased agent utilization, and an enhanced overall user experience for contacts and agents alike.

Additionally, in certain instances, the systems and methods of the present disclosure may utilize both a pre-determined agent capacity model and/or reinforcement learning models/techniques to determine customer response times and agent capacities in order to determine the optimal contact-agent assignments. In particular, the when methods of the present disclosure determine such customer response times and agent capacities, the systems and methods of the present disclosure may: utilize the pre-determined model to assign additional work items to an agent during idle times (e.g., when the agent is not engaged in responding to a contact), automatically switch focus to either bot or human agent utterances in the same conversation based on predictions of conversation cost and outcome gain, automatically switch the conversation to a different agent, automatically assign a multiple topic conversation to agents of specific top skill (e.g., billing resolution, plan change, equipment sale, etc.), allow the agents to view the queue and select conversations in order to acquire rewards on metrics devised by a client, and allow the agents to support multi-channel interactions where an idle agent can select a conversation from the queue and progress it while waiting for the next contact pairing.

Benefits arise from operating a multi-channel call center customer experience via user interfaces for a given contact center system. For example, a contact center, and its underlying systems, operations, and/or other aspects of the contact center in general, may experience a performance increase from implementation of such multi-channel chat interaction management. Such performance increases may stem from reductions in the number of contacts in queue at the contact center, reduced numbers of agents in queue at the contact center, or otherwise more efficient handling of the overall chat interaction load on the contact center at any given time. In other examples, such performance increases may stem from increased capacity at the contact center system to handle more contacts in queue and/or more agents in queue, and/or increased capacity to handle longer contact-agent interactions. More specifically, the systems and methods of the present disclosure dramatically improve agent multi-channel management, communication flexibility across multi-channel chat interactions, and positive chat interaction outcomes/dispositions in contact centers relative to conventional techniques. As a result, the systems and methods of the present disclosure enable agents to have significantly higher utilizations than conventional systems, such that, in one example, the agents may achieve more conversations handled per hour and ultimately increase the profitability and cost saving of the contact center. Other differences in performance may also include a number of transactions completed over a certain period of time, increase in transactions (e.g., sales) amount, or percentage sales increase, or the like.

In accordance with various aspects herein, methods, systems, and tangible, non-transitory computer-readable mediums are disclosed for transitioning a multi-channel call center customer experience via user interfaces. The methods, systems, and tangible, non-transitory computer-readable mediums may comprise obtaining, by a communications server, contact information of a contact. The methods, systems, and tangible, non-transitory computer-readable mediums may further comprise establishing, by the communications server, a first connection between a contact and an agent terminal over a first communication channel. The methods, systems, and tangible, non-transitory computer-readable mediums may further comprise establishing, by the communications server, a second connection between the contact and the agent terminal over a second communication channel. The methods, systems, and tangible, non-transitory computer-readable mediums may further comprise sending a first communication to the contact from the agent terminal across the second communication channel. The methods, systems, and tangible, non-transitory computer-readable mediums may further comprise receiving, at the agent terminal, a second communication from the contact across the second communication channel. The methods, systems, and tangible, non-transitory computer-readable mediums may further comprise displaying, in a communication panel of a graphical user interface (GUI) of the agent terminal, the first communication with a first visual indicator and the second communication with a second visual indicator, wherein the first visual indicator and the second visual indicator indicate communication channels across which the first communication and the second communication are respectively transmitted.

In further aspects, establishing the first connection comprises receiving, by the communications server from the agent terminal, a selection from an icon bar of the agent terminal, the icon bar comprising a portion of the GUI that is configured to switch between communication channels, the communication channels including one or more of: (i) a voice communication channel, (ii) a video communication channel, (iii) an email communication channel, (iv) a text message communication channel, (v) a messenger application communication channel, (vi) a screen-sharing communication channel, or (vii) a co-browsing communication channel.

In yet further aspects, the methods, systems, and tangible, non-transitory computer-readable mediums further comprise: receiving, at the agent terminal, the second communication from the contact across the second communication channel, wherein either the first communication channel or the second communication channel is configured to receive communications including one or more of: (i) audio data, (ii) video data, (iii) image data, or (iv) text data.

In still further aspects, the methods, systems, and tangible, non-transitory computer-readable mediums further comprise: clustering, by the communications server, one or more secondary communications of the second communication channel with one or more primary communications of the first communication channel into a communication channel cluster, wherein the first communication channel is a parent communication channel within the communication channel cluster and the second communication channel is a child communication channel within the communication channel cluster.

In yet further aspects, the agent terminal is a first agent terminal, and the methods, systems, and tangible, non-transitory computer-readable mediums further comprise: transferring the one or more primary communications of the first communication channel from the first agent terminal to a second agent terminal; identifying, by the communications server, that the first communication channel is the parent communication channel and that the second communication channel is the child communication channel; and transferring the one or more secondary communications of the second communication channel from the first agent terminal to the second agent terminal.

In still further aspects, the agent terminal is a first agent terminal, and the methods, systems, and tangible, non-transitory computer-readable mediums further comprise: receiving, by the communications server from the first agent terminal, a transfer request to transfer the one or more secondary communications of the second communication channel from the first agent terminal to a second agent terminal; identifying, by the communications server, that the second communication channel is the child communication channel within the communication channel cluster and that the first communication channel is the parent communication channel within the communication channel cluster; and transferring the one or more secondary communications of the second communication channel from the first agent terminal to the second agent terminal without transferring the one or more primary communications of the first communication channel from the first agent terminal to the second agent terminal.

In yet further aspects, the methods, systems, and tangible, non-transitory computer-readable mediums further comprise: receiving, at the GUI of the agent terminal, a selection indicating to apply a communication channel filter limiting communication to the first communication channel; removing, based on the communication channel filter, one or more communications transmitted across the second communication channel from a communication panel of the GUI; and displaying, in the communication panel of the GUI, one or more communications transmitted across the first communication channel.

In still further aspects, the methods, systems, and tangible, non-transitory computer-readable mediums further comprise: displaying, in a historical interaction panel of the GUI of the agent terminal, at least one of: (i) a prior communication between the contact and a second agent terminal, (ii) contact notes, or (iii) communication channel information corresponding to the first communication channel or the second communication channel.

In yet further aspects, methods, systems, and tangible, non-transitory computer-readable mediums further comprise: automatically sending the first communication to the contact from the agent terminal across the second communication channel based on a predefined response list.

In still further aspects, the agent terminal is a first agent terminal, the contact is a first contact of a plurality of contacts communicating with the first agent terminal, and the methods, systems, and tangible, non-transitory computer-readable mediums further comprise: determining, by the communications server, a cumulative active communication channel value corresponding to the first agent terminal; determining, by the communications server, a first capacity of the first agent terminal to receive communications across the first communication channel based on the cumulative active communication channel value; comparing, by the communications server, the first capacity to a capacity threshold; and routing, by the communications server, a new communication from a new contact to a second agent terminal based on the first capacity exceeding the capacity threshold.

In accordance with the above, and with the disclosure herein, the present disclosure includes improvements in underlying computer functionality or in improvements to other technologies at least because the present disclosure includes, e.g., dynamically detecting/establishing multiple connections between an agent and a contact across multiple communication channels, sending/receiving communications across the multiple communication channels, and displaying the communications in a communication panel with visual indicators indicating the respective communication channels. Such dynamic connection detection/establishment, multi-channel communication sending/receiving, and aggregate communication display may correspond to telecommunication connections or computing resources (e.g., memory and/or processor resources) of a contact center system comprising computing systems in the field of contact center routing, distribution, and/or management. That is, the present disclosure describes improvements in the functioning of an underlying computing system itself or “any other technology or technical field” because a contact center, and its underlying contact/interaction processing hardware and devices, are improved by allowing the contact center, and related resources, such as telecommunications connections allocated in the contact center system (e.g., telecommunications connections between an agent and a contact) to be routed/established, utilized, and the resulting communications displayed based on modules utilizing these systems and methods.

This provides an improvement over prior systems that do not implement such dynamic connection detection/establishment, multi-channel communication sending/receiving, and/or aggregate communication display, as described herein. For example, such implementation improves over the prior art at least because a contact center, as improved based on the dynamic connection detection/establishment, multi-channel communication sending/receiving, and aggregate communication display, as described herein, allow the systems and methods of the contact center to operate with limited or reduced resources (e.g., limited or fewer telecommunication connections and/or limited or reduced processing or memory utilization of a contact processing system) or experience increased performance (e.g., higher contact chat interaction throughput, higher agent utilization, higher contact center capacity) compared with conventional systems. Namely, pairing an agent of the contact center to a contact comprises establishing a telecommunication or other connection to provide voice, text, or other communication(s) between the agent and the contact. Such pairing may require not only telephonic connections, but may also require processor, memory, and networking connection and/or bandwidth of the contact center. The dynamic connection detection/establishment, multi-channel communication sending/receiving, and aggregate communication display described herein may be used to more efficiently manage multi-channel conversations between agents and contacts, which in turn, directly improves the allocation efficiency of such resources.

Additionally, or alternatively, the present disclosure relates to improvements to other technologies or technical fields at least because multiple communication channels between an agent and a contact may be automatically detected, established, utilized interchangeably, and the resulting communications displayed in a single interface. In this manner, the systems and methods of the present disclosure are used to improve the performance of one or more features of the contact center system, for example, by enabling an agent to seamlessly switch between any connected communication channel of a multi-channel chat interaction through a single GUI panel displaying visual indicators indicating the respective communication channels across which each individual communication was sent, and thereby providing an improvement in terms of increased chat interaction throughput, reduced overall connection resource usage, increased agent utilization, reduced memory usage, reduced processing usage, reduced handle time, and/or increased performance of transactions and/or sales, increased contact center capacity, increased agent and/or agent terminal capacity, or other benefits to the contact center as described herein.

In addition, the present disclosure includes the application of or use of a particular machine, e.g., a channel manager (also referenced herein as a “communications server” or a “channel manager service”) as deployed in a contact center, where the channel manager may be configured to perform dynamic connection detection/establishment, multi-channel communication sending/receiving, and aggregate communication display, in accordance with the systems and methods for transitioning a multi-channel call center customer experience via user interfaces, as described herein.

Still further, the present disclosure includes specific features other than what is well-understood, routine, conventional activity in the field, because such features add unconventional steps that confine the disclosure to a particular useful application, e.g., systems and methods within contact centers for transitioning a multi-channel call center customer experience via user interfaces through dynamic connection detection/establishment, multi-channel communication sending/receiving, and aggregate communication display.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The present disclosure will now be described in more detail with reference to particular aspects thereof as shown in the accompanying drawings. While the present disclosure is described below with reference to particular aspects, it should be understood that the present disclosure is not limited thereto. Those of ordinary skill in the art having access to the teachings herein will recognize additional implementations, modifications, and aspects, as well as other fields of use, which are within the scope of the present disclosure as described herein, and with respect to which the present disclosure may be of significant utility.

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1A depicts a block diagram of an example contact center system, in accordance with various aspects of the present disclosure.

FIG. 1B depicts a block diagram of a second example contact center system, in accordance with various aspects of the present disclosure.

FIG. 1C depicts a block diagram of an example communication system that includes an example configuration of a contact center as a service (CCaaS), in accordance with various aspects of the present disclosure.

FIG. 1D depicts a block diagram of a multi-tenancy embodiment of the example contact center system of FIG. 1B, in accordance with various aspects of the present disclosure.

FIG. 1E depicts a block diagram of an example chat interaction across one or more communication channels between a contact and at least one agent that is managed by the channel manager of FIG. 1A, in accordance with various aspects of the present disclosure.

FIG. 2A depicts a block diagram of a node at an example contact center system, in accordance with various aspects of the present disclosure.

FIG. 2B depicts a block diagram of an example graphical user interface (GUI) that enables an agent to view communications and interact with a contact through multiple communication channels simultaneously, in accordance with various aspects of the present disclosure.

FIG. 3 illustrates a method for transitioning a multi-channel call center customer experience via user interfaces, in accordance with aspects of the present disclosure.

FIG. 4 illustrates a method for transferring communications between agents in response to a first agent interacting with a transfer button displayed as a portion of a communication panel of the GUI of FIG. 2, in accordance with various aspects of the present disclosure.

FIG. 5 illustrates a method for establishing and sending predefined content to a contact through an agent interacting with a predefined content configuration button of the GUI of FIG. 2, in accordance with various aspects of the present disclosure.

FIG. 6 illustrates a method for routing new communications to an agent based on an agent-defined capacity threshold input by the agent interacting with a capacity button of the GUI of FIG. 2, in accordance with various aspects of the present disclosure.

### DETAILED DESCRIPTION

Contacts often utilize multiple communication channels during any given day. In fact, many contacts may prefer to conduct conversations across multiple communication channels in order to yield an optimal conversation experience. However, conventional contact center systems are limited to a single communication channel (e.g., only voice calls, or only web chat, or only business chat). For example, an agent may conduct an active conversation with a first contact through an Internet chat, and the first contact may desire to send the agent a document through email that is relevant to the conversation taking place through the Internet chat. While such multi-channel conversations can yield positive outcomes, agents are unable to actively converse across different communication channels while utilizing conventional systems. The present disclosure provides systems and methods to enable a contact center system with a unified agent interface to facilitate interaction between contacts and agents across multiple communication channels.

Further, with the various different communication channels available to contacts and managed by agents according to the present disclosure, conventional techniques for managing agent capacity are inadequate because conventional techniques lack any capability to aggregate conversations taking place across multiple channels in a manner that enables agents to keep conversations active across the various channels. Therefore, the present disclosure further provides systems and methods for managing a multi-channel call center customer experience via user interfaces.

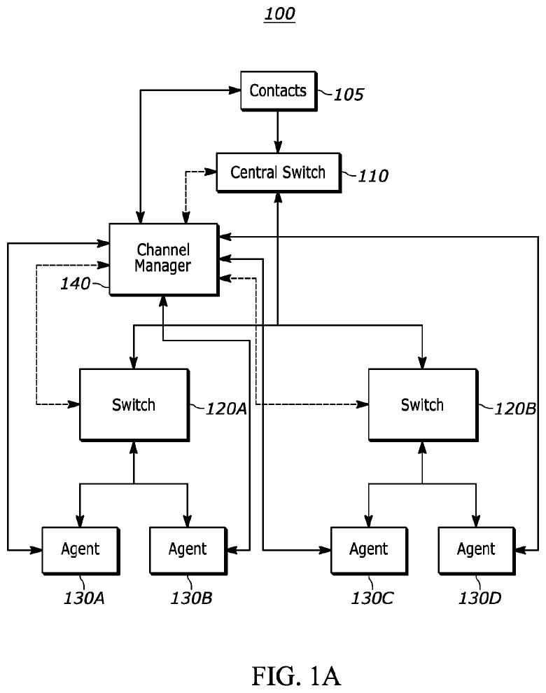

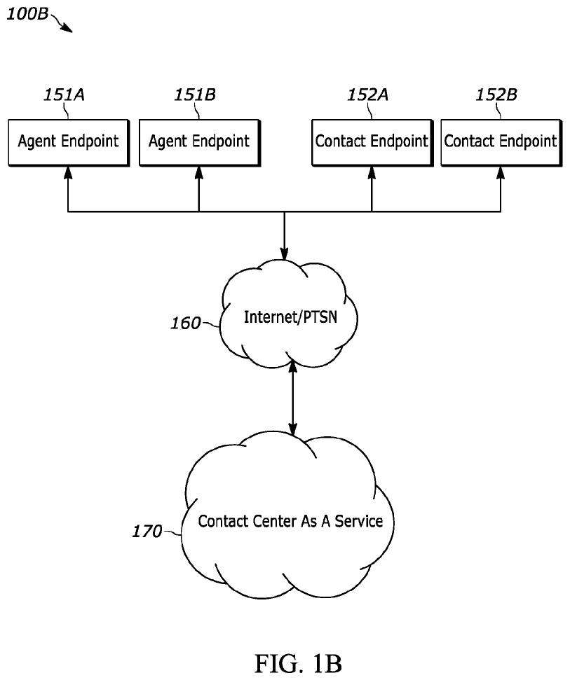

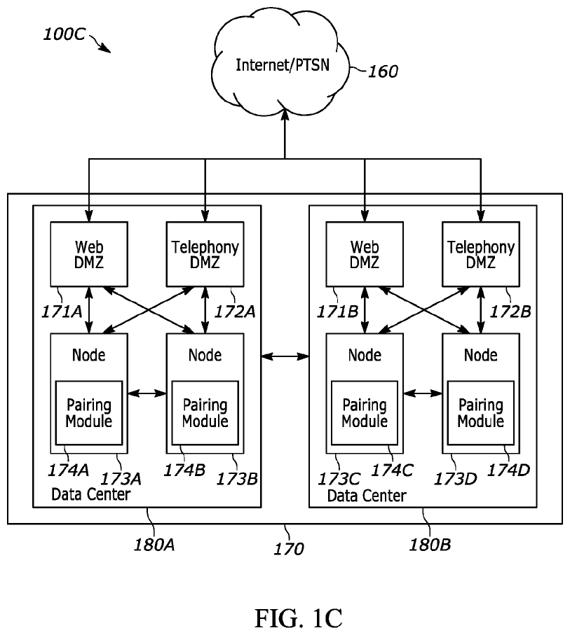

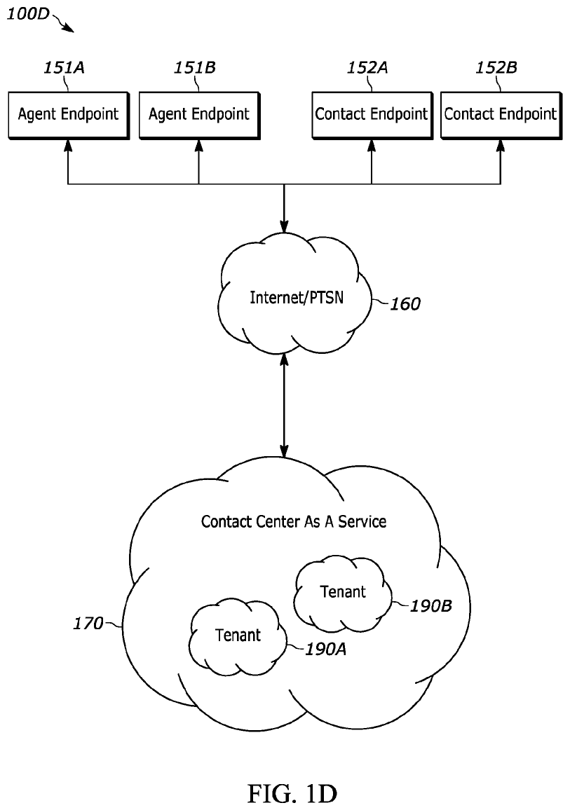

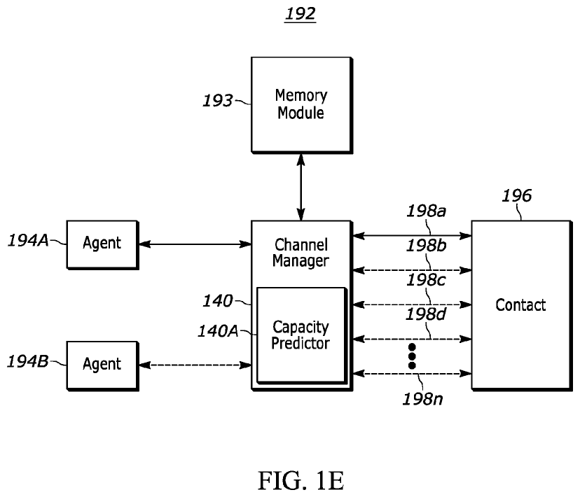

FIG. 1A depicts a block diagram of an example contact center system 100A, in accordance with various aspects of the present disclosure. As illustrated by the example contact center system 100A of FIG. 1A, the systems and methods herein comprise network elements, computers, and/or computing instructions for managing a multi-channel call center customer experience via user interfaces that may include one or more modules. As used herein, the term “module” may be understood to refer to computing software, instructions, firmware, hardware, and/or various combinations thereof. Modules, however, are not to be interpreted as software which is not implemented on hardware, firmware, or recorded on a processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

Moreover, while the interactions described with reference to FIG. 1A primarily describe contacts calling into the example contact center system 100A, it should be understood that the example contact center system 100A may support any suitable chat or messaging interactions, and indeed any suitable interactions across any type of platform (e.g., video, etc.). For example, the “chat or messaging interactions”, or simply “interactions”, described herein, may include, without limitation, contacts interacting with agents through text messaging (e.g., Apple iMessage, SMS, WhatsApp, etc.), application messaging (e.g., Facebook Messenger, Instagram Direct Messaging (DM), web messaging), email, voice chatting (e.g., live telephone call), chatbots, video calls, and/or any other suitable communication channel or combinations thereof, in any of a synchronous and/or asynchronous manner of communication. Further, in certain instances, the chat interactions between a single contact and a single agent may include one or more of the communication channels described herein, and the contact may be transferred to a different agent to continue the interaction through one or more of the communication channels and/or may simultaneously communicate to multiple agents across the same or different communication channels.

In any event, as shown in FIG. 1A, the example contact center system 100A may include a central switch 110. The central switch 110 may receive incoming contacts 105 (e.g., chat participants, text participants, callers) or support outbound connections to contacts via a dialer, a telecommunications network, or other modules (not shown). The central switch 110 may include contact routing hardware and software for helping to route contacts among one or more contact center systems, or to one or more Private Branch Exchanges (PBXs) and/or Automated Call Distribution (ACD) systems or other queuing or switching components within a contact center. For example, the PBX and/or ACD may manage, route, or otherwise distribute interactions based on one or more distribution rules, such as the number called, line, timetable, and other parameters, which are configurable to dynamically update or change the operation of the contact center. The rules of the PBX and/or ACD, or more generally the operation of the PBX and/or ACD, may be modified, updated, or otherwise configured by the channel manager 140.

In some aspects, the central switch 110 may not be necessary if there is only one contact center, or if there is only one PBX/ACD routing component, in the example contact center system 100A. If more than one contact center is part of the contact center system 100A, each contact center may include at least one contact center switch (e.g., contact center switches 120A and 120B). The contact center switches 120A and 120B may be communicatively coupled to the central switch 110.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-interaction functions such as logging information about the interaction, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B. It is to be understood, however, that additional or fewer agents may be allocated or otherwise associated with a given switch or router within a contact center system. Moreover, as referenced herein, each agent 130A-D may have an associated “agent identifier,” which the contact center system 100A, and more specifically, the channel manager 140 may dynamically detect/establish multiple connections between agents 130A-D and the contacts 105, send/receive multi-channel communications between the agents 130A-D and the contacts 105, display aggregate communications between the agents 130A-D and the contacts 105, track active and dormant interactions of the agents 130A-D, assign the agents 130A-D additional contacts 105, and/or perform other suitable actions or combinations thereof with respect to the agents 130A-D.

In various aspects, the contact center system 100A may also be communicatively coupled to a channel manager 140. The channel manager 140 may comprise a computing system including one or more processors, one or more memories, and related computing instructions for execution of software or instructions as described herein. In some aspects, the channel manager 140 may be integrated as part of the contact center system 100A, such as integrated into an existing computing device or server of the contact center. Additionally, or alternatively, the channel manager 140 may be a separate computing system (e.g., such as a computing device as provided by a third party) that is connected via a computer network of the contact center. That is, in some aspects, switches of the contact center system 100A may be communicatively coupled to the channel manager 140 via a network or otherwise cable connection, and, in some aspects, may include multiple channel managers like the channel manager 140. In the example of FIG. 1A, the channel manager 140 may be communicatively coupled to one or more switches in the switch system of the contact center system 100A, including the central switch 110, the contact center switch 120A, and the contact center switch 120B. Further, the channel manager 140 may be directly communicatively coupled to one or more of the contacts or agents that are included as part of the contact center system 100A, including the contacts 105, the agent 103A, the agent 130B, the agent 130C, and the agent 130D.

The channel manager 140 may receive data/information from a PBX/ACD of the contact center system 100A and/or a switch (e.g., contact center switch 120A) of the contact center system 100A about agents logged in to the switch or otherwise contact center system 100A (e.g., agents 130A and 130B) and about incoming contacts. In some aspects, such information may be received via another switch (e.g., central switch 110) or, in some aspects, from a network (e.g., the Internet or a telecommunications network) (not shown). For example, the channel manager 140 may receive/obtain data regarding contacts 105, such as a contact arriving or otherwise connecting at a contact center, a contact leaving or otherwise disconnecting from the contact center, a contact communicating to an agent across multiple different communication channels, or a contact's interactions with the contact center, which may include the contact's pairing by a pairing system, interactions with an agent, selections made (e.g., such as menu selections from a chat interface, number phone menu, and/or other selection interface causing the contact to be routed or directed in one or more ways within the routing network of the contact center system 100A), or any other event that defines interaction or status of the contact with the contact center. Similarly, as a further example, the channel manager 140 may receive/obtain data regarding agents, such as an agent logging into or otherwise connecting at a contact center, an agent logging out or otherwise disconnecting from the contact center, an agent communicating with a contact across multiple different communication channels, or an agent's interactions with the contact center, which may include the agent's pairing by a pairing system, interactions with a contact, selections made (e.g., such as menu selections from a menu while the agent handles or otherwise interacts with a contact), and/or any other event that defines interaction or status of the agent with the contact center.

The channel manager 140 may process this data to determine which contacts 105 should be paired (e.g., matched, assigned, distributed, or otherwise routed within contact center system 100A) with which agents 130A-D. That is, the channel manager 140, or more generally contact center system 100A, is configured to algorithmically assign contacts 105 arriving at the contact center to agents 130A-D available to handle those contacts 105. At times, the contact center may be in an “L1 state” as defined by a state where the contact center system 100A has agents 130A-D available and waiting for assignment to inbound or outbound contacts 105 (e.g., text messaging, Internet chat sessions, email, telephone calls, etc.). At other times, the contact center system 100A may be in an “L2 state” (i.e., an L2 queue) as defined by a state where the contact center system 100A has contacts 105 waiting in one or more queues for an agent 130A-D to become available for assignment. Such L2 queues could be inbound, outbound, or virtual queues. At other times, the contact center system 100A may be in an “L3 state” as defined by a state where the contact center system 100A has contacts 105 waiting in one or more queues for an agent 130A-D to become available for assignment and the contact center system 100A has agents 130A-D available and waiting for assignment to inbound or outbound contacts 105 (e.g., text messaging, Internet chat sessions, email, telephone calls, video calls, etc.).

The channel manager 140 may be configured to assign contacts 105 to agents 130A-D when the contact center system 100A is in any suitable state (e.g., L1, L2, L3 states) by tracking agent chat interactions to determine the number of active and dormant interactions for each agent 130A-D. For example, in one aspect, multiple agents 130A-D may be available and waiting for connection to a contact 105, and a contact 105 arrives at the contact center via a network or central switch. The channel manager 140 may automatically analyze the information associated with the contact 105, the capacities of the agents 130A-D, historical contact-agent interaction data, and/or any other suitable data in order to assign the contact 105 to an agent 103A-D.

Additionally, the channel manager 140 may be configured to obtain contact 105 information, detect/establish connections between contacts 105 and agents 130A-D, transmit communications between the contacts 105 and the agents 130A-D, and/or display communications between the contacts 105 and the agents 130A-D in a graphical user interface (GUI) rendered on agent terminals. For example, and as discussed herein, a contact 105 may submit a request for a chat interaction with an agent 130A-D, which may be received by the channel manager 140. The channel manager 140 may determine that agent 130B is an optimal contact-agent pairing for the contact 105, and may accordingly assign the contact 105 to agent 130B. When the agent 130B accepts the request in order to initiate the chat interaction, the channel manager 140 may establish a first connection between the contact 105 and the agent 130B across a first communication channel (e.g., Internet chat). The channel manager 140 may also detect/establish a second connection representing a second communication channel (e.g., text messaging) between the contact 105 and the agent terminal of the agent 130B, transmit a communication from the agent terminal to the contact 105 across the second communication channel, and receive a response from the contact 105 across the second communication channel. During this chat interaction, the channel manager 140 may also display each of the communications in a single GUI panel with visual indicators associated with each communication, and the visual indicators may indicate the communication channels across which each communication was respectively transmitted.

In any event, the information associated with the contact 105 and/or the historical contact-agent interaction data may include historical/current response time patterns for the contact 105 and/or contacts that are similar to the contact. For example, the information associated with the contact 105 and/or the historical contact-agent interaction data may include, without limitation, response time patterns associated with and/or related to any of the following: previous chat interactions involving the contact 105, a current chat interaction for the contact 105, contacts that have a similar contact type to the contact 105, the contact 105 or other contacts when participating in a chat interaction about a specific topic, contacts during the same day when the contact 105 attempts to initiate a chat interaction with an agent 130A-D, contacts during a similar time (e.g., time of day or specific date/time) when the contact 105 attempts to initiate a chat interaction with an agent 130A-D, contacts in the specific messaging channel (e.g., text messaging, Internet chat, email, etc.) in which the contact 105 attempts to initiate a chat interaction with an agent 130A-D, the contact 105 and/or all contacts in the specific messaging channel after a suitable number of messages, the contact 105 based on a number of previous chat interactions, the contact 105 based on a number of words used in a sentence, the contact 105 based on sentiment (e.g., via text analysis) of the chat interaction, the contact 105 based on an urgency of the issue discussed in the chat interaction, chat interactions stored in the chat interaction queue, the contact's 105 main language and the contact's 105 conversation language, the device type of a device utilized by the contact 105 to conduct the chat interaction, contacts conducting chat interactions with the same and/or similar device type to the contact 105, chat interactions with contact typing mistakes.

FIG. 1B depicts a block diagram of a second example contact center system 100B, in accordance with various aspects of the present disclosure. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN) 160, according to the capabilities of the endpoint device.

FIG. 1C depicts a block diagram of an example communication system 100C that includes an example configuration of a contact center as a service (CCaaS) 170, in accordance with various aspects of the present disclosure. For example, the CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to the CCaaS 170 via the Internet 160. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS 170 via the PSTN 160. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to the channel manager 140 of the contact center system 100A of FIG. 1A, the pairing modules 174A, 174B, 174C, 174D may pair contacts to agents. For example, the pairing modules 174A, 174B, 174C, 174D may alternate between enabling pairing via a Behavioral Pairing (BP) module and enabling pairing with a First-in-First-out (FIFO) module. For example, the pairing modules 174A, 174B, 174C, 174D may be configured to emulate other pairing strategies.

FIG. 1D depicts a block diagram of a multi-tenancy embodiment of the example contact center system of FIG. 1B, in accordance with various aspects of the present disclosure. In particular, the disclosed CCaaS communication systems (e.g., FIGS. 1B and/or 1C) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. The CCaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such that node 173A may support both tenants 190A and 190B, and similarly for nodes 173B, 173C, and 173D. In other embodiments, the system may be configured for a single tenant within a dedicated environment such as a private machine or private virtual machine.

FIG. 1E depicts a block diagram of an example chat interaction 192 across one or more communication channels 198a-n between a contact 196 and at least one agent (e.g., agents 194A, 194B) that is managed by the channel manager 140 of FIG. 1A, in accordance with various aspects of the present disclosure. In particular, the channel manager 140 includes a capacity predictor 140A that is generally configured to track/determine agent capacity and contact conversation patterns in order to determine optimal contact-agent pairings for chat interactions. The capacity predictor 140A may comprise computing instructions stored in memory and configured to execute one or more processors within, or communicatively coupled to, the channel manager 140. Generally, the capacity predictor 140A, may be integrated with (e.g., stored in memory with or as part of a set of computing instructions or application with) the channel manager 140. However, in certain aspects, the capacity predictor 140A may be implemented by a separate computing device (e.g., a server) communicatively connected (e.g., via a network or cable connection) to the channel manager 140.

As described further herein, the one or more communication channels 198a-n may include any suitable number and/or type of communication channels, such as Multimedia Messaging Service (MMS) messaging, Short Message Service (SMS) messaging, email, voice call, voice chat, video chat, Internet chat, WhatsApp, Facebook Messenger, Apple Business Chat, and/or any other communication channel or combinations thereof, whether synchronous or asynchronous communication. Further, a contact 196 may be simultaneously connected to one or more agents 194A, 194B through any suitable number of communication channels 198a-n. For example, a contact 196 may be simultaneously connected to one or more agents 194A, 194B through 3 separate communication channels 198a-c (e.g., MMS messaging, email, voice chat).

Generally speaking, through the channel manager 140, an agent (e.g., via an agent terminal (not shown)) may establish a connection to conduct an interaction through one or more communication channels 198a-n with any other party that is communicatively coupled to the channel manager 140, such as a supervisor/peer terminal (not shown) and/or the contact 196. The channel manager 140 may detect any of the one or more communication channels 198a-n when the contact 196 initially requests an interaction with an agent 194A-B. For example, the contact 196 may request a chat interaction through the contact's 196 mobile device (e.g., smartphone) across an Internet chat communication channel 198a. The channel manager 140 may receive the request across the Internet chat communication channel 198a, and may utilize the capacity predictor 140A to pair the contact 196 with the agent 194A. When the agent 194A accepts the assignment, the channel manager 140 may establish a connection between the contact 196 and the agent 194A across the Internet chat communication channel 198a. Thus, the contact 196 and the agent 194A may begin the chat interaction across the Internet chat communication channel 198a.

Continuing the prior example, the channel manager 140 may detect a second connection from the contact 196 that corresponds to a text messaging communication channel 198b. The channel manager 140 may receive, as part of the contact's 196 initial chat interaction request, a phone number associated with the contact's 196 mobile device. Additionally, or alternatively, the channel manager 140 may access a memory module 193 to retrieve/obtain information (e.g., the contact's 196 mobile phone number) related to the contact 196 with which the agent 194A is conducting the chat interaction. Regardless, the channel manager 140 may establish the second connection between the agent 194A and the contact 196 and present the agent 194A with the option to send a communication to the contact 196 across the text messaging communication channel 198b. In this manner, the channel manager 140 may detect and establish any suitable number of connections between an agent 194A and a contact 196 to communicate during a single chat interaction across any suitable number of communication channels 198a-n.

Once the channel manager 140 detects and establishes the second connection between the agent 194A and the contact 196, the agent 194A may select the option to send the communication to the contact 196 across the text messaging communication channel 198b. The agent 194A may select the text messaging communication channel 198b from a list of communication channels presented to the agent 194A by the channel manager 140, and the channel manager 140 may automatically switch the communication channel from the Internet chat communication channel 198a to the text messaging communication channel 198b, such that any subsequent communications from the agent 194A to the contact 196 are transmitted across the text messaging communication channel 198b. The agent 194A may submit a communication for transmission across the text messaging communication channel 198b, the channel manager 140 may send the communication across the channel 198b, and the contact 196 may receive the communication through the text messaging communication channel 198b.

However, the contact 196 may choose to respond to the agent's 194A text message through the Internet chat, and the agent 194A may receive the new communication from the contact 196 across the Internet chat communication channel 198a. The agent 194A may choose to respond to the contact 196 through the Internet chat communications channel 198a, so the agent 194A may select the Internet chat communication channel 198a from the list of communication channels presented to the agent 194A by the channel manager 140. In response, the channel manager 140 may automatically switch the communication channel from the text messaging communication channel 198b to the Internet chat communication channel 198a, such that any subsequent communications from the agent 194A to the contact 196 are transmitted across the Internet chat communication channel 198a. Accordingly, the agent 194A may submit a communication for transmission across the Internet chat communication channel 198a, the channel manager 140 may send the communication across the channel 198a, and the contact 196 may receive the communication through the Internet chat communication channel 198a.

Nevertheless, the channel manager 140 may automatically display all communications to/from the agent 194A in a communication panel of a GUI displayed to the agent 194A, such that the communications comprising the interaction (e.g., between the agent 194A and the contact 196) are listed in chronological order, regardless of communication channel, to allow the agent 194A to easily interpret the logical flow of the interaction. In certain aspects, and as described further herein, the channel manager 104 may filter the communications in the GUI to isolate communications to one or more communication channels 198a-n in response to selection from a channel filter list by the agent 194A. For example, the agent 194A may desire to view the communications transmitted across just the Internet chat communications channel 198a. In this example, the agent 194A may select the Internet chat communications channel 198a from the channel filter list, and the channel manager 140 may filter the displayed communications to display only those communications that were transmitted across the Internet chat communications channel 198a.

Moreover, the channel manager 140 may display all communications comprising the interaction with visual indicators that indicate the respective communications channels 198a-n through which the communications were transmitted. Continuing the above example, the communications transmitted across the Internet chat communications channel 198a would include an associated Internet chat visual indicator, and the communications transmitted across the text messaging communications channel 198b would include an associated text messaging visual indicator.

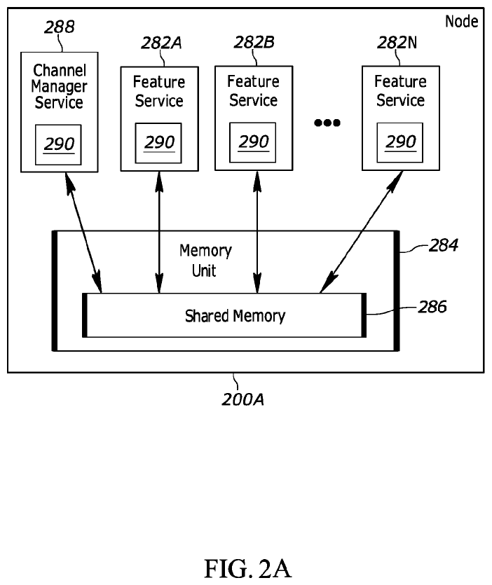

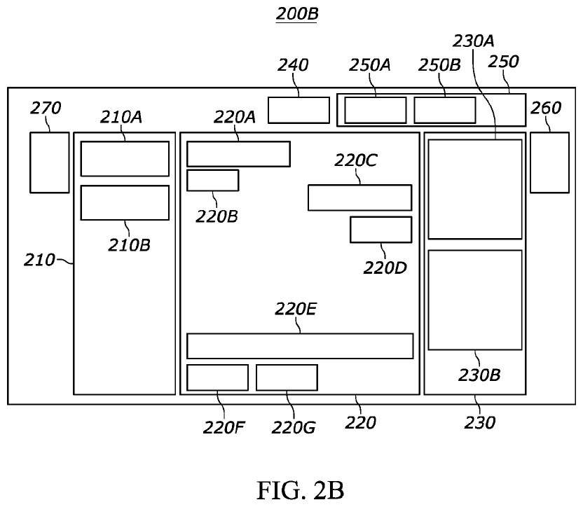

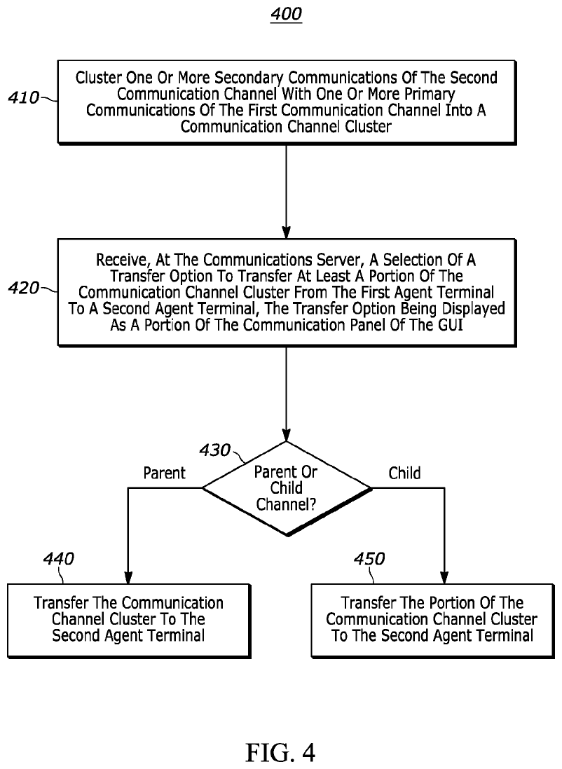

Additionally, in certain aspects, the agent 194A may desire and/or need to transfer all or a portion of the interaction to another agent 194B. The channel manager 140 may display a transfer option to the agent 194A through the GUI, and the agent 194A may select the transfer option to transfer the portion(s) of the interaction. Continuing the above example, the agent 194A may select the transfer option in order to transfer the text messaging communication channel 198b to the agent 198B. The channel manager 140 may receive the selection from the agent 194A, and may transfer the connection of the text messaging communication channel 198b from the agent 194A to the agent 194B, as well as the communications transmitted across the text messaging communication channel 198b and/or the other communication channels 198a-n included as part of the interaction. In this manner, the agent 194B may receive the necessary communications to understand the purpose of the interaction, and may automatically have a communication channel (198b) to begin communicating with the contact 196 once the connection transfer by the channel manager 140 is completed. In some aspects, the communication channels 198a-n may have and/or otherwise be related to one another, such that transferring one communication channel 198a-n may necessarily require transferring some/all other related communication channels 198a-n. The relationships between/among communication channels 198a-n are further discussed herein in reference to FIGS. 2A, 2B, and 4.

Returning to FIG. 1E, the channel manager 140 may access the memory module 193 in order to retrieve/obtain information related to contacts 196. For example, if the agent 194A connects to the interaction with the contact 196 through the channel manager 140, then the agent 194A may access memory module 193 to obtain information about the contact 196 participating in the chat interaction. The memory module 193 may store information related to a contact 196 or another agent 194B, such as, number of prior interactions, length of prior interactions, channel type (e.g., MMS/SMS message, Internet chat, email, phone call, etc.) of prior interactions, contact 196 type information, and/or any other suitable data or combinations thereof. Thus, in this manner, the agent 194A may obtain information from the memory module 193 about the contact 196 and/or another agent 194B before, during, or after an interaction.

Moreover, before, during, and/or after such interactions, the capacity predictor 140A may obtain and/or analyze data related to the agent 194A-B and the contact 196 to track/determine agent capacity and contact conversation data and/or patterns in order to determine optimal contact-agent pairings for chat interactions. Namely, the capacity predictor 140A may track an agent's 194A-B interactions, and more specifically a number of active communication channels, in order to determine an agent's 194A-B capacity at any given time. An “active” communication channel may generally indicate a channel in which the most recent response provided by the contact was transmitted within an interaction period threshold (e.g., 5 minutes, 30 minutes, 1 hour, etc.) or within an interaction frequency threshold (e.g., only 1 message per 5 minutes, only 1 message per 5 hours, etc.), and a “dormant” communication channel may generally indicate a channel in which the most recent response provided by the contact was not transmitted within the interaction period threshold or within the interaction frequency threshold. In any event, the capacity predictor 140A may also make decisions related to the determined agent capacity, such as whether or not an agent 194A-B has sufficient capacity to handle an additional interaction/communication channel, when the agent 194A-B will likely have sufficient capacity to handle an additional interaction/communication channel, and/or what type(s) of interactions/communication channels the agent 194A-B may have capacity to handle. Thus, the capacity predictor 140A may alleviate interaction queue build-up and maximize agent utilization by dynamically analyzing the capacity of each individual agent 194A-B.

As part of this dynamic agent capacity analysis, the capacity predictor 140A may determine an agent's 194A-B capacity based on the number of active interactions/communication channels and dormant chat interactions/communication channels currently handled by the agent 194A-B. For example, the capacity predictor 140A may combine the number of active communication channels a particular agent 194A-B has to yield a cumulative active communication channel value. The capacity predictor 140A may then determine a capacity of the agent 194A-B based on the cumulative active communication channel value. The capacity of the agent 194A-B may determine whether or not the agent 194A-B has available capacity to accept additional interaction assignments across a communication channel and/or in general, and the capacity may be a dynamic allocation between the active interactions/communication channels and the dormant interactions/communication channels currently assigned to the agent 194A-B. As a result, the capacity predictor 140A enables a contact system to dynamically assign contacts 196 to agents 194A-B based on an interpretation of the agent's 194A-B capacity, such as predicted response times for each of the agent's 194A-B assigned interactions/communication channels (active and dormant).

The channel manager 140 may also analyze information associated with a contact 196 in order to determine a conversation pattern of the contact 196. The conversation pattern of a contact 196 may generally indicate a level of interaction/engagement required from an agent 194A-B in order to successfully dispose and/or otherwise terminate the chat interaction. For example, a conversation pattern for a first contact may indicate that an agent 194A-B may need to respond relatively quickly (e.g., within 1 minute or less) to the first contact, and that the entire interaction may take place over a relatively short timeframe (e.g., 10 minutes or less). In this example, the channel manager 140 may analyze response times and interaction disposition times for three agents (e.g., a first agent, a second agent, and a third agent), and may determine that the second agent has a typical response time and interaction disposition time that is similar to the conversation pattern for the first contact. Thus, the channel manager 140 may assign the first contact to the second agent.

The channel manager 140 may obtain/receive information associated with the contact 196 from, for example, the request to initiate the interaction transmitted by the contact 196, the memory module 193, and/or any other suitable location or combinations thereof. For example, the request transmitted by the contact 196 in order to initiate the interaction may include contextual data (e.g., metadata) that the channel manager 140 may analyze to determine a conversation pattern, such as a contact's 196 country, a contact's 196 customer type (e.g., high priority contact, low priority contact, contact requiring extensive interaction with agent, etc.), products purchased by the contact 196, number of prior interactions with the contact 196, a contact's 196 type, and/or other suitable contextual data or combinations thereof. Based on this contextual data, the channel manager 140 may determine and/or update a contact's 196 conversation pattern in order to assign the contact 196 to an optimal agent (e.g., agents 194A-B).

Additionally, or alternatively, the channel manager 140 may analyze a contact's 196 responses to an agent 194A during an interaction to actively update the contact's 196 conversation pattern. For example, the channel manager 140 may include and/or access a natural language processing (NLP) module (not shown) or other suitable language analysis software in order to analyze (e.g., parse, interpret, etc.) the contact's 196 responses during the interaction. Based on this analysis of the contact's 196 responses, the channel manager 140 may update the contact's 196 conversation pattern to better reflect the current conversation patterns of the contact 196. If, for example, the updated conversation pattern of the contact 196 indicates that the agent 194B is a more ideal/optimal fit for the contact 196 than the agent 194A, then the channel manager 140 may display the transfer option to the agent 194A, the agent 194A may choose to transfer the communications and communication channel connections to the agent 194B, and the channel manager 140 may transfer the communications and communication channel connections to the agent 194B in order to enable the agent 194B to progress the interaction with the contact 196.

As mentioned, the capacity predictor 140A may generally receive inputs from the contact 196, the agents 194A-B, the memory module 193, and/or any other suitable location or combinations thereof to output a capacity of an agent 194A-B. In certain instances, outputting the agent capacity may be or include a prediction of an expected capacity of the agent 194A-B, which may include and/or otherwise indicate a predicted compatibility between the agent 194A-B and the contact 196 (e.g., a predicted contact-agent match).

The capacity predictor 140A may be trained using data corresponding to contacts 196 and agents 194A-B. Namely, the capacity predictor 140A may be trained using a training dataset comprising historical contact-agent interaction data, agent capacities, and conversation patterns of contacts. This historical contact-agent interaction data may include historical data related to a contact's and/or an agent's interactions with agent's/contact's during chat interactions, such as message frequency, messages from the contact/agent, contextual information (e.g., products purchased by the contact, number of prior interactions with the contact), and/or other suitable historical interaction data or combinations thereof. Using this training dataset, the capacity predictor 140A may be trained to output the capacity of an agent 194A-B and/or a prediction of an expected capacity of an agent 194A-B.

Additionally, or alternatively, the capacity predictor 140A may be or include a machine learning (ML) model configured to receive inputs from the contact 196, the agents 194A-B, the memory module 193, and/or any other suitable location or combinations thereof to output a capacity of an agent 194A-B and/or a prediction of an expected capacity of an agent 194A-B. For example, the capacity predictor 140A may include a machine learning model, or algorithm for training a machine learning model, that is configured to receive historical contact-agent interaction data, agent capacities, and/or conversation patterns of contacts as input in order to output predictions of expected capacities of agents and/or contact-agent pairings. The capacity predictor 140A may be trained to determine optimal contact-agent pairings that are included as part of the predictions of expected capacities of agents.

In various aspects, a machine learning model of the capacity predictor 140A may be trained using a reinforcement machine learning program or algorithm, a supervised machine learning program or algorithm, or an unsupervised machine learning program or algorithm. The machine learning program or algorithm may employ, for example, a state-action-reward-state (SARS) algorithm, which may be a state-action-reward-state-action (SARSA) algorithm. In some aspects, the artificial intelligence and/or machine learning based algorithms, as used to train the capacity predictor 140A, may be included as a library.

Machine learning as applied to the capacity predictor 140A may involve identifying and recognizing patterns in existing data, such as historical contact-agent interaction data, agent capacities, and conversation patterns of contacts, in order to facilitate making predictions or identification for subsequent data (such as predicting expected capacities of agents and/or contact-agent pairings). For example, a machine learning model, such as the machine learning model of the capacity predictor 140A, as described herein, may be created and trained based upon training data (e.g., data or information regarding contacts, agents, arrival times, log in or log out times, handle times, sales or transaction information, telecommunication connection status or utilization, memory or processor resource utilization of the contact center system, or other information or data described herein) as inputs or data (which may be termed “features” and “labels”) in order to make valid and reliable predictions for new inputs, such as testing level or production level data or inputs (e.g., for predicting expected capacities of agents and/or contact-agent pairings).

Generally speaking, in reinforcement machine learning, a machine learning program operating on a server, computing device, or otherwise processors, is tasked with performing actions (e.g., predicting expected capacities of agents) in an environment in order to maximize a cumulative reward. Reinforcement learning does not require labelled input/output pairs be presented, and similarly does not rely upon explicit corrections to sub-optimal actions. Instead, reinforcement learning primarily focuses on determining a balance between exploration of unknown relationships and exploitation of known relationships. Many reinforcement learning algorithms also use dynamic programming techniques, and the environment is typically stated in the form of a Markov decision process (MDP).

In supervised machine learning, a machine learning program operating on a server, computing device, or otherwise processors, may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processors as described herein, to predict or classify, based on the discovered rules, relationships, or model, an expected output, score, or value.

In unsupervised machine learning, the server, computing device, or otherwise processors, may be required to find its own structure in unlabeled example inputs, where, for example multiple training iterations are executed by the server, computing device, or otherwise processors to train multiple generations of models until a satisfactory model, e.g., a model that provides sufficient prediction accuracy when given test level or production level data or inputs, is generated.

Reinforcement learning, supervised learning, and/or unsupervised machine learning may also comprise retraining, relearning, or otherwise updating models with new, or different, information, which may include information received, ingested, generated, or otherwise used over time. The disclosures herein may use one or more of such reinforcement, supervised, or unsupervised machine learning techniques.

It is to be understood that capacity predictor 140A may be used to determine capacities of agents 194A-B and/or predictions of expected agent capacity, using artificial intelligence (e.g., a machine learning model of capacity predictor 140A) or, in alternative aspects, without using artificial intelligence.

FIG. 2A depicts a block diagram of a generic node 200A at an example contact center system, in accordance with various aspects of the present disclosure. That is, for example, nodes 173A, 173B, 173C, 173D of FIG. 1C may be implemented using pairing node 200A. In the embodiment shown, node 200 includes modules (e.g., microservices), such as, for example, the modules described in FIG. 1E (e.g., channel manager 140, capacity predictor 140A, etc.) and a shared memory segment (SHM) 286 within memory 284. Specifically, in the example shown, node 200A includes three microservices: channel manager service 288, and feature services 282A, 282B, . . . . —N. For example, there may be a separate feature service for each channel, which detects, establishes, and manages contact-agent interactions across said channel. For example, there may be a web messaging features service, a chat messaging feature service, a video feature service, a texting feature service, a voice feature service, etc.

Each microservice includes a shared memory submodule 290 (a.k. a., shared memory library (SHM_lib)) that enables the microservice in which it is contained to read from and write to SHM 286. In one embodiment, each microservice is contained within its own container (e.g., a Docker® container). In one embodiment, one or more of the modules described in FIG. 1E (e.g., channel manager 140, capacity predictor 140A, etc.) a includes an instance of SHM_lib 290. In some embodiments, each microservice is trusted to operate on shared memory segment 286 through functions of SHM_lib 290, eliminating the need for an operating system kernel to manage memory protection among different microservices. Moreover, each microservice may be developed and maintained more efficiently because any complexity of operating on shared memory segment 286 is implemented and managed by the SHM_lib 290 of each microservice.

FIG. 2B depicts a block diagram of an example graphical user interface (GUI) 200 that enables an agent to view communications and interact with a contact through multiple communication channels simultaneously, in accordance with various aspects of the present disclosure. The example GUI 200B may be rendered by the channel manager (e.g., channel manager 140), or the various microservices of node 200A, at an agent's terminal (e.g., an agent's computing device) in order to enable the agent to perform many of the actions described herein with respect to the systems and methods of the present disclosure. More specifically, and as a result of an agent interacting with the example GUI 200B, the example GUI 200B may enable an agent to view/send communications and other data across multiple communication channels corresponding to interactions with a contact that are handled by the agent.

The example GUI 200A includes an interaction panel 210, a communication panel 220, a historical interaction panel 230, a communication channel filter button 240, an icon bar 250, a contact profile button 260, and a transfer button 270. The present disclosure contemplates that any of the components of GUI 200A may be in any arrangement, and may be visible or hidden at different times, according to various embodiments of the present disclosure.

Generally speaking, the interaction panel 210, the communication panel 220, and the historical interaction panel 230 may display all relevant information related to a contact and a corresponding interaction that an agent may want and/or require in order to successfully conduct the interaction with the contact. For example, the interaction panel 210 may display interaction indications 210A, 210B that are each representative of contact interaction sets currently handled by an agent. By selecting one of the interaction indications 210A, 210B, the agent may transition from, for example, a first set of interactions with a first contact (corresponding to interaction indication 210A) to a second set of interactions with a second contact (corresponding to interaction indication 210B). Further, as a result of transitioning from a first set of interactions to a second set of interactions, the channel manager 140 may cause the communication panel 220 to change the displayed communications from communications of the first set of interactions with the first contact to communications of the second set of interactions with the second contact.

Accordingly, the communication panel 220 generally displays communications 220A, 220C transmitted by either the agent or a selected contact, and may enable the agent to transmit subsequent communications, configure predefined content, and/or configure capacities of the agent with the selected contact. In particular, the communication panel 220 includes a first communication 220A, a first visual indicator 220B, a second communication 220C, a second visual indicator 220D, a communication entry field 220E, a predefined content configuration button 220F, and a capacity button 220G.

The first communication 220A may generally represent a communication received from a contact, and that is displayed to an agent for reading/response. The first visual indicator 220B may generally be an indication of a communication channel, across which, the first communication 220A was transmitted to the agent, and the indicator 220B may be and/or include characters, numbers, images, symbols, and/or any other suitable graphical representation or combinations thereof. For example, the first communication 220A may be transmitted across a text message communication channel, such that the first visual indicator 220B may be and/or include a text bubble graphic representing the text message communication channel. Similarly, as another example, the first communication 220A may be transmitted across a voice/telephone communication channel, such that the first visual indicator 220B may be and/or include a telephone image/graphic representing the voice/telephone communication channel.

The second communication 220C may generally represent a communication entered by an agent into the communication entry field 220E for transmission to a contact in response to the first communication 220A. The second visual indicator 220D may generally be an indication of a communication channel, across which, the second communication 220C was transmitted to the contact, and the indicator 220D may be and/or include characters, numbers, images, symbols, and/or any other suitable graphical representation or combinations thereof. For example, the second communication 220C may be transmitted across an email communication channel, such that the second visual indicator 220D may be and/or include an envelope image/graphic representing the email communication channel. Similarly, as another example, the second communication 220C may be transmitted across an Internet chat communication channel, such that the second visual indicator 220B may be and/or include a cloud image/graphic representing the Internet chat communication channel.

The predefined content configuration button 220F and the capacity button 220G generally enable an agent to configure various aspects of the chat interactions displayed on the GUI 200. Namely, the predefined content configuration button 220F enables an agent to configure automatic responsive communications to contacts in the event that, for example, an agent is responding to a first contact when a second contact communicates with the agent. The automatic responsive communications may include predefined content that the agent manually inputs using the predefined content configuration button 220F, quick replies to contact communications that satisfy certain criteria, rich links that provide contacts with selectable links to answer contact questions and/or otherwise inform the contacts, list pickers that provide contacts with a series of predefined prompts/responses that contacts may click and/or otherwise interact with in order to receive desired information, and/or any other suitable automatic responsive communications or combinations thereof.

The capacity button 220G enables an agent to define capacities for the agent based on various metrics and for various communication channels. In particular, an agent interacting with the capacity button 220G may be presented with various options and/or other GUIs (not shown) to define the agent's capacity threshold for interactions and communication channels. These options may include an option to define a capacity threshold for interactions communicated over voice communication channels, chat communication channels (e.g., Internet chat), email communication channels, messaging communication channels (e.g., MMS, SMS), and/or any other communication channels. The options may also provide more granular definition capabilities for the agent, such that the agent may define when the agent may receive new interactions over any suitable communication channel based on the current number of interactions the agent has over each individual communication channel type. For example, the capacity button 220G may enable an agent to define that the agent can receive new interactions across an email communication channel if the agent has fewer than 2 interactions across a voice communication channel, fewer than 3 interactions across a chat communication channel, fewer than 4 interactions across the email communication channel, and fewer than 3 interactions across a messaging communication channel.

In some examples, the capacity button 220G is inaccessible to specific agents, and is available to a manager who sets capacity thresholds for all agents at the contact center system.

Thus, the channel manager 140 (e.g., the capacity predictor 140A) or the various microservices of node 200A may determine when the agent's capacity has reached/exceeded the agent's defined capacity threshold, and that new interactions should be routed to other agents. For example, the channel manager 140 or the various microservices of node 200A may determine the agent's capacity based on the agent's cumulative active communication channel value, the manager 140 or the various microservices of node 200A may compare the agent's capacity to the agent's defined capacity threshold, and the manager 140 or the various microservices of node 200A may assign/route a new contact to another agent if the agent's capacity exceeds the agent's defined capacity threshold.

The historical interaction panel 230 generally includes information relating to historical interactions a particular contact has conducted with one or more agents at a contact center. The historical interaction panel 230 may display a prior interaction transcript 230A that lists the communications between the contact and an agent during a prior interaction. Similar to the communication panel 220, the prior interaction transcript 230A may include visual indicators for each of the communications represented in the prior interaction to indicate which communication channel was used during the prior interaction. The prior interaction transcript 230A may also include an indication of the prior agent that participated in the interaction with the contact, such that an agent viewing the transcript 230A may contact the prior agent to discuss the transcript 230A, if appropriate.

The historical interaction panel 230 may also include contact notes 230B that may include aggregate notes about the contact that were recorded by one or more agents corresponding to one or more of the prior interactions in which the contact participated. For example, the contact notes 230B may indicate that the contact prefers to communicate across a text messaging communication channel, and that the contact prefers not to communicate across a voice communication channel. Accordingly, the agent viewing the historical interaction panel 230 may determine that communicating with the contact across a text messaging communication channel may be an optimal form of communication in order to increase responsiveness/throughput.

The communication channel filter button 240 and the icon bar 250 may generally enable an agent to filter communication channels used to communicate with a contact during an interaction. More specifically, the communication channel filter button 240 may enable an agent to selectively filter the communications displayed in the communication panel 220. For example, an agent may desire that only communications transmitted across a text messaging communications channel are displayed in the communication panel 220. The agent may interact with the communication channel filter button 240, which may render a list, a pop-up box, and/or other suitable selection field that includes each communication channel type across which the agent has either transmitted a communication to the contact and/or can transmit a communication to the contact. The agent may select the text messaging communication channel from the selection field, and the channel manager 140 may filter the communications that have been transmitted as part of the interaction to display only those communications that were transmitted across the text messaging communication channel. Of course, it should be appreciated that the communication channel filter button 240 may enable an agent to select multiple communication channels for the channel manager 140 to filter (e.g., text messaging communication channel and voice communication channel).

The icon bar 250 may enable an agent to select a communication channel, across which, subsequent communications from the agent to the contact may be transmitted. Accordingly, the icon bar 250 may include multiple icons 250A, 250B that correspond to the various communication channels the agent may use to transmit communications to the contact. The icons 250A, 250B may be or include characters, numbers, images, symbols, and/or any other suitable graphical representation or combinations thereof. For example, an agent may desire that a subsequent communication to a contact is transmitted across a text messaging communications channel, and the agent may interact (e.g., click, tap, swipe, gesture, etc.) with the text message icon 250A on the icon bar 250. The channel manager 140 and/or the various microservices of node 200A may then switch the communication channel to the text messaging communication channel, and a subsequent communication entered by the agent into the communication entry field 220E may be transmitted to the contact across the text messaging communication channel. Further in this example, the agent may then desire that a second subsequent communication to a contact is transmitted across an email communications channel, and the agent may interact (e.g., click, tap, swipe, gesture, etc.) with the email icon 250B on the icon bar 250. The channel manager 140 and/or the various microservices of node 200A may then switch the communication channel from the text messaging communication channel to the email communication channel. Accordingly, the second subsequent communication entered by the agent into the communication entry field 220E may be transmitted to the contact across the email communication channel, in that an email containing the contents of the second subsequent communication may be sent to the contact's email account across the email communication channel.

The contact profile button 260 may generally enable an agent to view and/or otherwise retrieve/obtain information about a contact with whom the agent is conducting a chat interaction. When an agent interacts with the button 260, the channel manager 140 and/or the various microservices of node 200A may, for example, access the memory module 193 or the SHM 286 to retrieve information about the contact, and may display the contact information in the historical interaction panel 230. Additionally, or alternatively, the contact may interact with the contact profile button 260 in order to enter information about the contact for storage at the memory module 193 or the SHM 286 and/or any other suitable location.

The transfer button 270 may generally enable an agent to electively transfer communications to other agents. When an agent interacts with the transfer button 270, the channel manager 140 may request that the agent specify which communication channels the agent desires to transfer for a selected contact. The agent may input specific communication channels of a particular interaction, and/or the agent may indicate that an entire interaction should be transferred to another agent. In a first example, the channel manager 140 and/or the various microservices of node 200A may then present the agent with transfer options that may include current agents who have capacity to handle the interaction(s) and/or communication channels indicated by the agent. The agent may then further select an agent or agents to receive the indicated chat interaction(s) and/or communication channels, and the channel manager 140 and/or the various microservices of node 200A may request that the indicated agent(s) accept the transfer. If the indicated agent(s) accept the transfer, then the channel manager 140 may transfer the communications corresponding to the indicated interaction(s) and/or the communication channels, as well as the connections across the corresponding communication channels so that the accepting agents may continue the interaction with the contact across the transferred communication channel. In a second example, the interaction(s) and/or communication channels indicated by the agent may be sent to an interaction queue, available for servicing by the next available agent, or to a pool of available agents, such that an agent is selected by the channel manager 140 and/or the various microservices of node 200A, according to various capacity determinations as discussed previously herein.

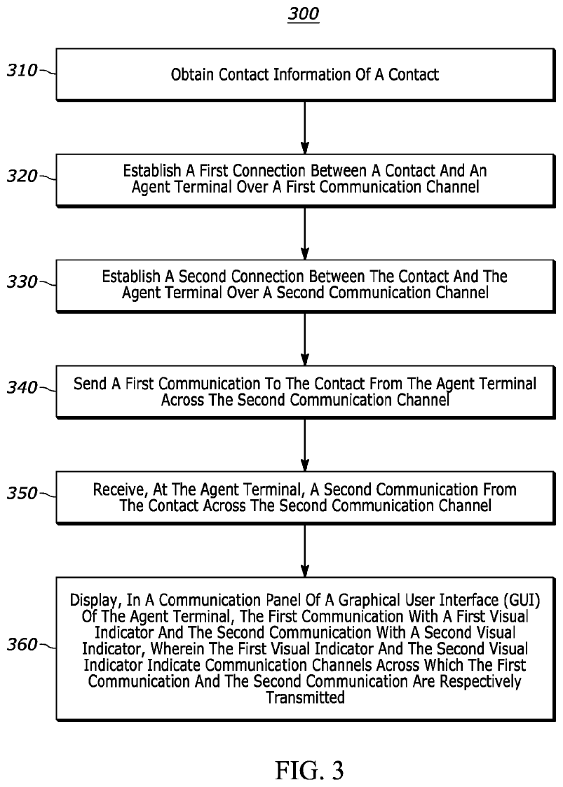

FIG. 3 illustrates a method 300 for transitioning a multi-channel call center customer experience via user interfaces, in accordance with aspects of the present disclosure. The method 300 comprises an algorithm or computing instructions, as may be implemented in a contact center or contact center system (e.g., contact center system 100A), and may involve the processing of input data and the generation of output data, both of which may comprise call center related data, including data regarding agents, contacts (or events thereof, including arrival of contacts and/or capacity of agents), and/or communications between agents and contacts, and other data, as described herein. Input data and output data receipt, transmission, and/or generation may be implemented in hardware or software components of a contact center system. For example, specific electronic components may be employed in a reinforcement learning algorithm, as implemented on one or more processors and/or memories of a contact center system (e.g., contact center system 100A), or similar or related circuitry for implementing the functions associated with transitioning a multi-channel call center customer experience via user interfaces.

Additionally, one or more processors operating in accordance with computing instructions may implement the functions associated with transitioning a multi-channel call center customer experience via user interfaces, as described herein, including for method 300. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 300, or otherwise execute the computing instructions as described herein, may comprise one or more processors of a computing device of the contact center system itself, such as one or more processors of a computing device, server (e.g., channel manager 140 and/or the microservices of node 200A), router, or the like that is communicatively coupled to the contact center system.

The method 300 includes obtaining, by a communications server, contact information of a contact (block 310). The method 300 further includes establishing, by the communications server, a first connection between a contact and an agent terminal over a first communication channel (block 320). In certain aspects, the method 300 further includes receiving, by the communications server from the agent terminal, a selection from an icon bar of the agent terminal. In these aspects, the icon bar comprises a portion of the GUI (e.g., GUI 200) that is configured to switch between communication channels. The communication channels may include one or more of: (i) a voice communication channel, (ii) a video communication channel, (iii) an email communication channel, (iv) a text message communication channel, (v) a messenger application communication channel, (vi) a screen-sharing communication channel, or (vii) a co-browsing communication channel.

The method 300 further includes establishing, by the communications server, a second connection between the contact and the agent terminal over a second communication channel (block 330). Establishing the second connection between the contact and the agent terminal may be based on, for example, the contact information of the contact. The method 300 further includes sending a first communication to the contact from the agent terminal across the second communication channel (block 340). The method 300 further includes receiving, at the agent terminal, a second communication from the contact across the second communication channel (block 350). In some aspects, the method 300 further includes receiving, at the agent terminal, the second communication from the contact across the second communication channel. Further in these aspects, either the first communication channel or the second communication channel may be configured to receive communications including one or more of: (i) audio data, (ii) video data, (iii) image data, or (iv) text data.

The method 300 further includes displaying, in a communication panel of a graphical user interface (GUI) of the agent terminal, the first communication with a first visual indicator and the second communication with a second visual indicator (block 360). As mentioned, the first visual indicator and the second visual indicator indicate communication channels across which the first communication and the second communication are respectively transmitted.

In certain aspects, the method 300 further includes receiving, at the GUI of the agent terminal, a selection (e.g., at the communication channel filter button 240) indicating to apply a communication channel filter limiting communication to the first communication channel. Further in these aspects, the method 300 may further include removing, based on the communication channel filter, one or more communications transmitted across the second communication channel from a communication panel of the GUI. Moreover, the method 300 may further include displaying, in the communication panel (e.g., communication panel 220) of the GUI, one or more communications transmitted across the first communication channel.

In some aspects, the method 300 may further include displaying, in a historical interaction panel (e.g., historical interaction panel 230) of the GUI of the agent terminal, at least one of: (i) a prior communication between the contact and a second agent terminal, (ii) contact notes, or (iii) communication channel information corresponding to the first communication channel or the second communication channel.

FIG. 4 illustrates a method 400 for transferring communications between agents in response to a first agent interacting with a transfer button 270 displayed as a portion of a communication panel 220 of the GUI 200 of FIG. 2, in accordance with various aspects of the present disclosure. The method 400 comprises an algorithm or computing instructions, as may be implemented in a contact center or contact center system (e.g., contact center system 100A), and may involve the processing of input data and the generation of output data, both of which may comprise call center related data, including data regarding agents, contacts (or events thereof, including arrival of contacts and/or capacity of agents), and/or communications between agents and contacts, and other data, as described herein. Input data and output data receipt, transmission, and/or generation may be implemented in hardware or software components of a contact center system. For example, specific electronic components may be employed in a reinforcement learning algorithm, as implemented on one or more processors and/or memories of a contact center system (e.g., contact center system 100A), or similar or related circuitry for implementing the functions associated with transferring communications between agents in response to a first agent interacting with a transfer button 270.

Additionally, one or more processors operating in accordance with computing instructions may implement the functions associated with transferring communications between agents in response to a first agent interacting with a transfer button 270, as described herein, including for method 400. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 400, or otherwise execute the computing instructions as described herein, may comprise one or more processors of a computing device of the contact center system itself, such as one or more processors of a computing device, server (e.g., channel manager 140 and/or the microservices of node 200A), router, or the like that is communicatively coupled to the contact center system.

The method 400 includes clustering, by the communications server, one or more secondary communications of the second communication channel with one or more primary communications of the first communication channel into a communication channel cluster (block 410). The first communication channel may be a parent communication channel within the communication channel cluster and the second communication channel may be a child communication channel within the communication channel cluster. Generally speaking, the parent communication channel may be a highest priority channel, such that if the parent communication channel is transferred to a first agent, all child communication channels are also transferred to the first agent. Accordingly, the child communication channels are lower priority channels, such that if a first child communication channel is transferred to a first agent, then only the first child communication channel (and any child channels to the first child communication channel) are transferred to the first agent. Thus, the parent communication channel may remain with a second agent, and the first child communication channel (and any child channels) may be transferred to the first agent.

In any event, the method 400 further includes receiving at the communications server, a selection of a transfer option (e.g., via transfer button 270) to transfer at least a portion of the communication channel cluster from the first agent terminal to a second agent terminal (block 420). The transfer option may be displayed as a portion of the communication panel (e.g., communication panel 220) of the GUI (e.g., GUI 200), and in certain instances, the transfer option may be or include the transfer button 270.

The method 400 further includes determining whether or not the indicated portion of the communication channel cluster includes a parent communication channel or just children communication channels (block 430). If the channel manager 140 determines that the indicated portion of the communication channel cluster includes a parent communication channel (Parent branch of block 430), then the method 400 may further include transferring the communication channel cluster to the second agent terminal (block 440). However, if the channel manager 140 determines that the indicated portion of the communication channel cluster includes only children communication channels (Child branch of block 430), then the method 400 may further include transferring the portion of the communication channel cluster to the second agent terminal (block 450).

In certain aspects, the agent terminal is a first agent terminal, and the method 400 further includes transferring the one or more primary communications of the first communication channel from the first agent terminal to a second agent terminal. Further in these aspects, the method 400 may include identifying, by the communications server, that the first communication channel is the parent communication channel and that the second communication channel is the child communication channel. The method 400 may additionally include transferring the one or more secondary communications of the second communication channel from the first agent terminal to the second agent terminal.

In some aspects, the agent terminal is a first agent terminal, and the method 400 further includes receiving, by the communications server from the first agent terminal, a transfer request to transfer the one or more secondary communications of the second communication channel from the first agent terminal to a second agent terminal. Further in these aspects, the method 400 may include identifying, by the communications server, that the second communication channel is the child communication channel within the communication channel cluster and that the first communication channel is the parent communication channel within the communication channel cluster. In these aspects, the method 400 may also include transferring the one or more secondary communications of the second communication channel from the first agent terminal to the second agent terminal without transferring the one or more primary communications of the first communication channel from the first agent terminal to the second agent terminal.

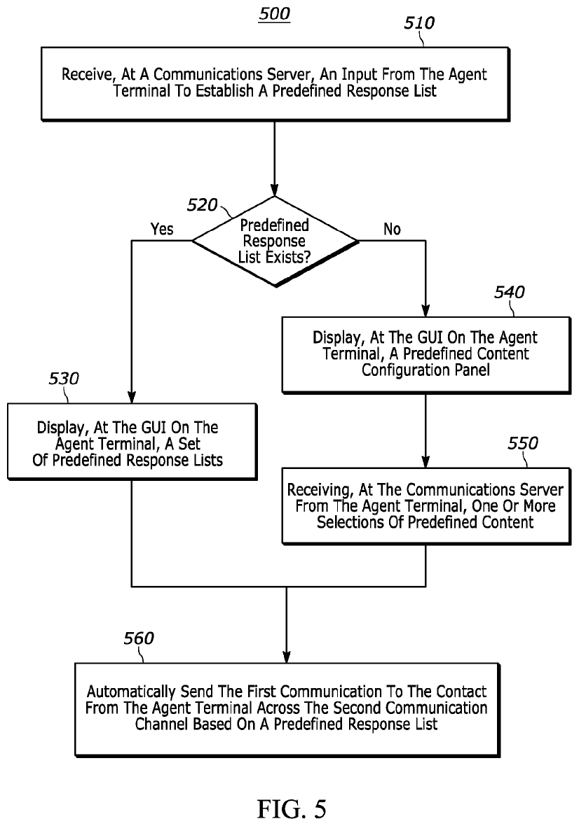

FIG. 5 illustrates a method 500 for establishing and sending predefined content to a contact through an agent interacting with a predefined content configuration button 220F of the GUI 200 of FIG. 2, in accordance with various aspects of the present disclosure. The method 500 comprises an algorithm or computing instructions, as may be implemented in a contact center or contact center system (e.g., contact center system 100A), and may involve the processing of input data and the generation of output data, both of which may comprise call center related data, including data regarding agents, contacts (or events thereof, including arrival of contacts and/or capacity of agents), and/or communications between agents and contacts, and other data, as described herein. Input data and output data receipt, transmission, and/or generation may be implemented in hardware or software components of a contact center system. For example, specific electronic components may be employed in a reinforcement learning algorithm, as implemented on one or more processors and/or memories of a contact center system (e.g., contact center system 100A), or similar or related circuitry for implementing the functions associated with establishing and sending predefined content to a contact through an agent interacting with a predefined content configuration button 220F.

Additionally, one or more processors operating in accordance with computing instructions may implement the functions associated with establishing and sending predefined content to a contact through an agent interacting with a predefined content configuration button 220F, as described herein, including for method 500. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 500, or otherwise execute the computing instructions as described herein, may comprise one or more processors of a computing device of the contact center system itself, such as one or more processors of a computing device, server (e.g., channel manager 140 and/or the microservices of node 200A), router, or the like that is communicatively coupled to the contact center system.

The method 500 includes receiving, at a communications server, an input from the agent terminal to establish a predefined response list (block 510). The method 500 further includes determining whether or not a predefined response list exists (block 520). For example, the channel manager 140 and/or the various microservices of node 200A may access the memory module 193 and/or the SHM 286 and/or any other suitable storage location to determine whether or not the agent has previously defined a predefined response list. If the channel manager 140 and/or the various microservices of node 200A determines that a predefined response list does exist (YES branch of block 520), then the method 500 may proceed to block 530. If the channel manager 140 and/or the various microservices of node 200A determines that a predefined response list does not exist (NO branch of block 520), then the method 500 may proceed to block 540.

At block 530, the method 500 may include displaying, at the GUI on the agent terminal, the set of predefined response lists. However, at block 540, the method 500 includes displaying, at the GUI on the agent terminal, a predefined content configuration panel. The predefined content configuration panel may be displayed in response to the agent interacting with the predefined content configuration button 220F. Thereafter, the method 500 may include receiving, at the communications server from the agent terminal, one or more selections of predefined content (block 550). Moreover, the method 500 may further include automatically sending the first communication to the contact from the agent terminal across the second communication channel based on a predefined response list (block 560).

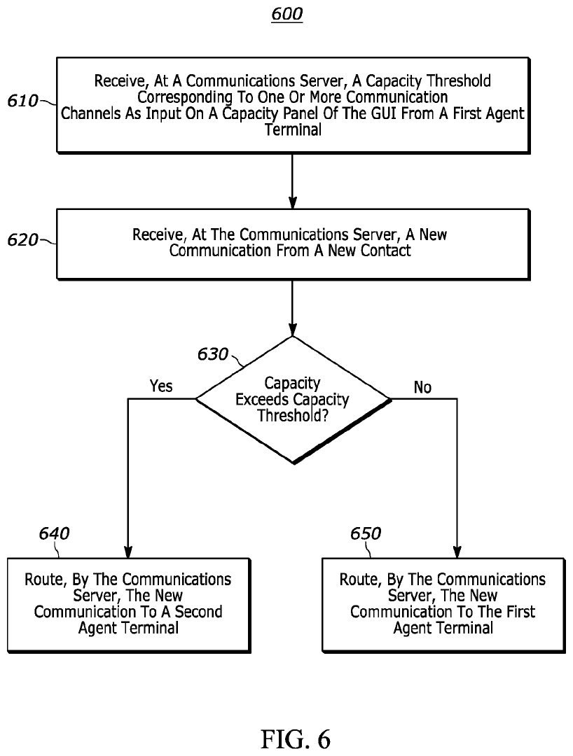

FIG. 6 illustrates a method for routing new communications to an agent based on an agent-defined capacity threshold input by the agent interacting with the capacity button 220G of the GUI 200 of FIG. 2, in accordance with various aspects of the present disclosure. The method 600 comprises an algorithm or computing instructions, as may be implemented in a contact center or contact center system (e.g., contact center system 100A), and may involve the processing of input data and the generation of output data, both of which may comprise call center related data, including data regarding agents, contacts (or events thereof, including arrival of contacts and/or capacity of agents), and/or communications between agents and contacts, and other data, as described herein. Input data and output data receipt, transmission, and/or generation may be implemented in hardware or software components of a contact center system. For example, specific electronic components may be employed in a reinforcement learning algorithm, as implemented on one or more processors and/or memories of a contact center system (e.g., contact center system 100A), or similar or related circuitry for implementing the functions associated with routing new communications to an agent based on an agent-defined capacity threshold input by the agent interacting with the capacity button 220G.

Additionally, one or more processors operating in accordance with computing instructions may implement the functions associated with routing new communications to an agent based on an agent-defined capacity threshold input by the agent interacting with the capacity button 220G, as described herein, including for method 600. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 600, or otherwise execute the computing instructions as described herein, may comprise one or more processors of a computing device of the contact center system itself, such as one or more processors of a computing device, server (e.g., channel manager 140 and/or the various microservices of node 200A), router, or the like that is communicatively coupled to the contact center system.

The method 600 includes receiving, at a communications server, a capacity threshold corresponding to one or more communication channels as input on a capacity panel of the GUI from a first agent terminal (block 610). The method 600 further includes receiving, at the communications server, a new communication from a new contact (block 620).

The method 600 may further include determining whether or not the agent's capacity exceeds a capacity threshold (block 630). As previously mentioned, the agent may manually define a capacity threshold through interacting with the capacity button 220G. If the channel manager 140 and/or the various microservices of node 200A determine that the agent's capacity does not exceed the capacity threshold (YES branch of block 630), then the method 600 may further include routing, by the communications server, the new communication to a second agent terminal (block 640). However, if the channel manager 140 and/or the various microservices of node 200A determine that the agent's capacity does exceed the capacity threshold (NO branch of block 630), then the method 600 may further include routing, by the communications server, the new communication to the first agent terminal (block 650).

In certain aspects, the agent terminal is a first agent terminal, the contact is a first contact of a plurality of contacts communicating with the first agent terminal, and the method 600 further includes determining, by the communications server, a cumulative active communication channel value corresponding to the first agent terminal. In these aspects, the method 600 may further include determining, by the communications server, a first capacity of the first agent terminal to receive communications across the first communication channel based on the cumulative active communication channel value. Further, the method 600 may include comparing, by the communications server, the first capacity to a capacity threshold, and routing, by the communications server, a new communication from a new contact to a second agent terminal based on the first capacity exceeding the capacity threshold.

### Additional Considerations

The present techniques may involve the processing of input data and the generation of output data to some extent. This input data processing and output data generation may be implemented in hardware or software. For example, specific electronic components may be employed in a channel manager or similar or related circuitry for implementing the functions associated with a transitioning multi-channel call center customer experience via user interfaces, in accordance with the present disclosure as described above. Alternatively, one or more processors operating in accordance with instructions may implement the functions associated with a transitioning multi-channel call center customer experience via user interfaces, in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The description herein describes network elements, computers, and/or components that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The present disclosure is not to be limited in scope by the specific aspects described herein. Indeed, other various aspects of and modifications to the present disclosure, in addition to those described herein, will be apparent to those of ordinary skill in the art from the foregoing description and accompanying drawings. Thus, such other aspects and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

What is claimed is:

1. A method comprising:
obtaining, by a communications server, contact information of a contact;
establishing, by the communications server, a first connection between a contact and an agent terminal over a first communication channel;
establishing, by the communications server, a second connection between the contact and the agent terminal over a second communication channel;
sending a first communication to the contact from the agent terminal across the second communication channel;
receiving, at the agent terminal, a second communication from the contact across the second communication channel; and
displaying, in a communication panel of a graphical user interface (GUI) of the agent terminal, the first communication with a first visual indicator and the second communication with a second visual indicator, wherein the first visual indicator and the second visual indicator indicate communication channels across which the first communication and the second communication are respectively transmitted.

2. The method of claim 1, wherein establishing the first connection comprises receiving, by the communications server from the agent terminal, a selection from an icon bar of the agent terminal, the icon bar comprising a portion of the GUI that is configured to switch between communication channels, the communication channels including one or more of: (i) a voice communication channel, (ii) a video communication channel, (iii) an email communication channel, (iv) a text message communication channel, (v) a messenger application communication channel, (vi) a screen-sharing communication channel, or (vii) a co-browsing communication channel.

3. The method of claim 1, further comprising:
receiving, at the agent terminal, the second communication from the contact across the second communication channel, wherein either the first communication channel or the second communication channel is configured to receive communications including one or more of: (i) audio data, (ii) video data, (iii) image data, or (iv) text data.

4. The method of claim 1, further comprising:
clustering, by the communications server, one or more secondary communications of the second communication channel with one or more primary communications of the first communication channel into a communication channel cluster, wherein the first communication channel is a parent communication channel within the communication channel cluster and the second communication channel is a child communication channel within the communication channel cluster.

5. The method of claim 4, wherein the agent terminal is a first agent terminal, and the method further comprises:
transferring the one or more primary communications of the first communication channel from the first agent terminal to a second agent terminal;
identifying, by the communications server, that the first communication channel is the parent communication channel and that the second communication channel is the child communication channel; and
transferring the one or more secondary communications of the second communication channel from the first agent terminal to the second agent terminal.

6. The method of claim 4, wherein the agent terminal is a first agent terminal, and the method further comprises:
receiving, by the communications server from the first agent terminal, a transfer request to transfer the one or more secondary communications of the second communication channel from the first agent terminal to a second agent terminal;
identifying, by the communications server, that the second communication channel is the child communication channel within the communication channel cluster and that the first communication channel is the parent communication channel within the communication channel cluster; and
transferring the one or more secondary communications of the second communication channel from the first agent terminal to the second agent terminal without transferring the one or more primary communications of the first communication channel from the first agent terminal to the second agent terminal.

7. The method of claim 1, further comprising:
receiving, at the GUI of the agent terminal, a selection indicating to apply a communication channel filter limiting communication to the first communication channel;
removing, based on the communication channel filter, one or more communications transmitted across the second communication channel from a communication panel of the GUI; and
displaying, in the communication panel of the GUI, one or more communications transmitted across the first communication channel.

8. The method of claim 1, further comprising:
displaying, in a historical interaction panel of the GUI of the agent terminal, at least one of: (i) a prior communication between the contact and a second agent terminal, (ii) contact notes, or (iii) communication channel information corresponding to the first communication channel or the second communication channel.

9. The method of claim 1, further comprising:
automatically sending the first communication to the contact from the agent terminal across the second communication channel based on a predefined response list.

10. The method of claim 1, wherein the agent terminal is a first agent terminal, the contact is a first contact of a plurality of contacts communicating with the first agent terminal, and the method further comprises:
determining, by the communications server, a cumulative active communication channel value corresponding to the first agent terminal;
determining, by the communications server, a first capacity of the first agent terminal to receive communications across the first communication channel based on the cumulative active communication channel value;
comparing, by the communications server, the first capacity to a capacity threshold; and
routing, by the communications server, a new communication from a new contact to a second agent terminal based on the first capacity exceeding the capacity threshold.

11. A communications system comprising:
one or more processors; and
a non-transitory computer-readable medium coupled to the one or more processors and storing instructions thereon that, when executed by the one or more processors, cause the communications system to:
obtain, by a communications server, contact information of a contact,
establish, by the communications server, a first connection between a contact and an agent terminal over a first communication channel,
establish, by the communications server, a second connection between the contact and the agent terminal over a second communication channel,
send a first communication to the contact from the agent terminal across the second communication channel,
receive, at the agent terminal, a second communication from the contact across the second communication channel, and
display, in a communication panel of a graphical user interface (GUI) of the agent terminal, the first communication with a first visual indicator and the second communication with a second visual indicator, wherein the first visual indicator and the second visual indicator indicate communication channels across which the first communication and the second communication are respectively transmitted.

12. The communications system of claim 11, wherein the instructions, when executed by the one or more processors, further cause the communications system to:
receive, by the communications server from the agent terminal, a selection from an icon bar of the agent terminal, the icon bar comprising a portion of the GUI that is configured to switch between communication channels, the communication channels including one or more of: (i) a voice communication channel, (ii) a video communication channel, (iii) an email communication channel, (iv) a text message communication channel, (v) a messenger application communication channel, (vi) a screen-sharing communication channel, or (vii) a co-browsing communication channel.

13. The communications system of claim 11, wherein the instructions, when executed by the one or more processors, further cause the communications system to:
receive, at the agent terminal, the second communication from the contact across the second communication channel, wherein either the first communication channel or the second communication channel is configured to receive communications including one or more of: (i) audio data, (ii) video data, (iii) image data, or (iv) text data.

14. The communications system of claim 11, wherein the instructions, when executed by the one or more processors, further cause the communications system to:
cluster one or more secondary communications of the second communication channel with one or more primary communications of the first communication channel into a communication channel cluster, wherein the first communication channel is a parent communication channel within the communication channel cluster and the second communication channel is a child communication channel within the communication channel cluster.

15. The communications system of claim 14, wherein the agent terminal is a first agent terminal, and wherein the instructions, when executed by the one or more processors, further cause the communications system to:
transfer the one or more primary communications of the first communication channel from the first agent terminal to a second agent terminal;
identify that the first communication channel is the parent communication channel and that the second communication channel is the child communication channel; and
transfer the one or more secondary communications of the second communication channel from the first agent terminal to the second agent terminal.

16. The communications system of claim 14, wherein the agent terminal is a first agent terminal, and wherein the instructions, when executed by the one or more processors, further cause the communications system to:
receive, by the communications server from the first agent terminal, a transfer request to transfer the one or more secondary communications of the second communication channel from the first agent terminal to a second agent terminal;
identify that the second communication channel is the child communication channel within the communication channel cluster and that the first communication channel is the parent communication channel within the communication channel cluster; and
transfer the one or more secondary communications of the second communication channel from the first agent terminal to the second agent terminal without transferring the one or more primary communications of the first communication channel from the first agent terminal to the second agent terminal.

17. The communications system of claim 11, wherein the instructions, when executed by the one or more processors, further cause the communications system to:
receive, at the GUI of the agent terminal, a selection indicating to apply a communication channel filter limiting communication to the first communication channel;
remove, based on the communication channel filter, one or more communications transmitted across the second communication channel from a communication panel of the GUI; and
display, in the communication panel of the GUI, one or more communications transmitted across the first communication channel.

18. The communications system of claim 11, wherein the instructions, when executed by the one or more processors, further cause the communications system to:
display, in a historical interaction panel of the GUI of the agent terminal, at least one of: (i) a prior communication between the contact and a second agent terminal, (ii) contact notes, or (iii) communication channel information corresponding to the first communication channel or the second communication channel.

19. The communications system of claim 11, wherein the agent terminal is a first agent terminal, the contact is a first contact of a plurality of contacts communicating with the first agent terminal, and wherein the instructions, when executed by the one or more processors, further cause the communications system to:
determine a cumulative active communication channel value corresponding to the first agent terminal;
determine a first capacity of the first agent terminal to receive communications across the first communication channel based on the cumulative active communication channel value;
compare the first capacity to a capacity threshold; and
route a new communication from a new contact to a second agent terminal based on the first capacity exceeding the capacity threshold.

20. A tangible, non-transitory computer-readable medium storing instructions that, when executed by one or more processors of a computing device, cause the computing device to:
obtain contact information of a contact;
establish a first connection between a contact and an agent terminal over a first communication channel;
establish a second connection between the contact and the agent terminal over a second communication channel;
send a first communication to the contact from the agent terminal across the second communication channel;
receive a second communication from the contact across the second communication channel; and
display, in a communication panel of a graphical user interface (GUI) of the agent terminal, the first communication with a first visual indicator and the second communication with a second visual indicator, wherein the first visual indicator and the second visual indicator indicate communication channels across which the first communication and the second communication are respectively transmitted.
